(19) United States
(12) Patent Application Publication
(10) Pub. No.: US 2021/0065164 A1
(43) Pub. Date: Mar. 4, 2021

(54) GLOBAL ACCOUNT CONSOLIDATION

(71) Applicant: Wells Fargo Bank, N.A., San Francisco, CA (US)

(72) Inventors: Stephen Godfrey, Palo Alto, CA (US); Kristin K. Koppelman, Bloomington, MN (US); Thomas M. Pendolino, Burlingame, CA (US); Nicole A. Douglas, San Anselmo, CA (US); Lori S. Fernando, San Francisco, CA (US)

(21) Appl. No.: 14/977,402

(22) Filed: Dec. 21, 2015

(51) Int. Cl. G06Q 20/38; G06Q 20/10

(52) U.S. Cl. CPC G06Q 20/381; G06Q 20/108

(57) ABSTRACT

Techniques for global account consolidation are generally described. An example server system is configured to group a first financial account associated with a first country and a second financial associated with a second country to form a consolidated global account, and to receive a transaction request associated with the consolidated global account for the first and second financial accounts. The example server system is further configured to determine an exchange rate applicable to the transaction request between respective currencies of the first and second countries, to deduct a first transaction amount from the first financial account based on the transaction request and the exchange rate, and to add a second transaction amount to the second financial account based on the transaction request and the exchange rate, the adding and deducting being responsive to determining that the first and second financial accounts are both included in the consolidated global account.

### TECHNICAL FIELD

This disclosure relates to electronic data processing, and in various examples, to the intake, maintenance, and output of data relating to financial records and transactions.

### BACKGROUND

Computing systems and databases are becoming increasingly popular as mechanisms by which customers access personal and business-related financial information at various financial institutions. For instance, online banking systems provide interactive interfaces through which customers may view financial information or perform various financial transactions. With increasing globalization of the world's economies, more and more individuals and businesses may maintain financial accounts in different countries. As such, a given individual or business may use separate online banking systems to monitor and operate different financial accounts hosted at various financial institutions throughout the world.

### SUMMARY

Aspects of this disclosure describe systems and techniques for implementing a consolidated online banking system with respect to multiple financial accounts based in different countries. At various portions of this disclosure, the consolidated banking system is referred to as a “true global account.” Currently, online banking systems may not be integrated, in that the online banking systems may maintain separate databases and implement different interfaces for financial accounts hosted in different countries. As such, a customer may need to log in to a different online banking system to monitor each financial account in each country. Moreover, technical, economic, and regulatory hurdles may keep the customer from performing international transactions with ease and efficiency.

Systems and techniques of this disclosure, in some examples, may mitigate or potentially eliminate one or more technical issues arising from the disjointed nature of using online banking systems to operate financial accounts that are hosted in different countries. For instance, some implementations of the described systems may pool account information from separate international financial institutions, enabling one-stop access to multiple international accounts via a single online banking portal. Systems of this disclosure can also be implemented to effect financial transactions in real-time between internationally dispersed accounts. Various systems and techniques described herein target open loop and closed loop banking systems, which are described in further detail below.

In one example, a method includes grouping, by a server system, a first financial account associated with a first country and a second financial account associated with a second country to form a consolidated global account and receiving, by the server system, a transaction request associated with the consolidated global account, the transaction request being for the first financial account and the second financial account. The method further includes determining, by the server system, a currency exchange rate applicable to the transaction request, where the currency exchange rate is associated with respective currencies of the first country and the second country, and deducting, by the server system, a first transaction amount from the first financial account based on the transaction request and the currency exchange rate, where the deducting is responsive to determining that the first financial and account and the second financial account are both included in the consolidated global account. The method further includes adding, by the server system, a second transaction amount to the second financial account based on the transaction request and the currency exchange rate, where the adding is responsive to determining that the first financial and account and the second financial account are both included in the consolidated global account

In another example, a server system includes one or more memory devices configured to store digital financial data, and one or more processors for processing at least a portion of the digital financial data. The one or more processors may be configured to group a first financial account associated with a first country and a second financial associated with a second country to form a consolidated global account, and to receive a transaction request associated with the consolidated global account, the transaction request being for the first financial account and the second financial account. The one or more processors may further be configured to determine a currency exchange rate applicable to the transaction request, where the currency exchange rate is associated with respective currencies of the first country and the second country, to deduct a first transaction amount from the first financial account based on the transaction request and the currency exchange rate, where the deducting is responsive to determining that the first financial and account and the second financial account are both included in the consolidated global account, and to add a second transaction amount to the second financial account based on the transaction request and the currency exchange rate, where the adding is responsive to determining that the first financial and account and the second financial account are both included in the consolidated global account.

In another example, a method includes obtaining, by a computing device, first account information that represents a financial account operating in a first national jurisdiction, obtaining, by the computing device, second account information that represents a financial account operating in a second national jurisdiction, the second national jurisdiction being mutually exclusive to the first national jurisdiction and outputting a combination of the first account information and the second account information via a consolidated user interface (UI).

In another example, a computing device includes a memory configured to store digital financial data and a middleware system for processing at least a portion of the digital financial data. The middleware system may be configured to obtain first account information that represents a financial account operating in a first national jurisdiction, to obtain second account information that represents a financial account operating in a second national jurisdiction, the second national jurisdiction being mutually exclusive to the first national jurisdiction, and output a combination of the first account information and the second account information via a consolidated user interface (UI).

The systems and techniques described herein may provide one or more potential advantages over existing technologies. For instance, the systems of this disclosure may reduce the usage of resources (e.g., computing resources, financial costs, human effort, etc.) currently consumed by performing international financial transactions. Additionally, the systems of this disclosure enable users to monitor internationally dispersed accounts more easily and to perform international transactions faster and at lower costs.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating details of a computing device and a user interface (UI) for a globally consolidated online banking system, in accordance with one or more aspects of this disclosure.

FIG. 2 is a conceptual diagram illustrating details of an example UI for performing global financial transactions using a globally consolidated online banking system using a computing device, in accordance with one or more aspects of this disclosure.

FIG. 3 is a block diagram illustrating details of an example server system for implementing globally consolidated online banking, in accordance with one or more aspects of this disclosure.

FIG. 4 is a conceptual diagram illustrating an example interactive UI that a computing device may implement for payment management using a globally consolidated online banking system, in accordance with one or more aspects of this disclosure.

FIG. 5 is a flowchart illustrating an example process that a client device may perform to implement one or more global account consolidation techniques of this disclosure.

FIG. 6 is a flowchart illustrating an example process that a server system may perform to implement one or more global account consolidation techniques of this disclosure.

### DETAILED DESCRIPTION

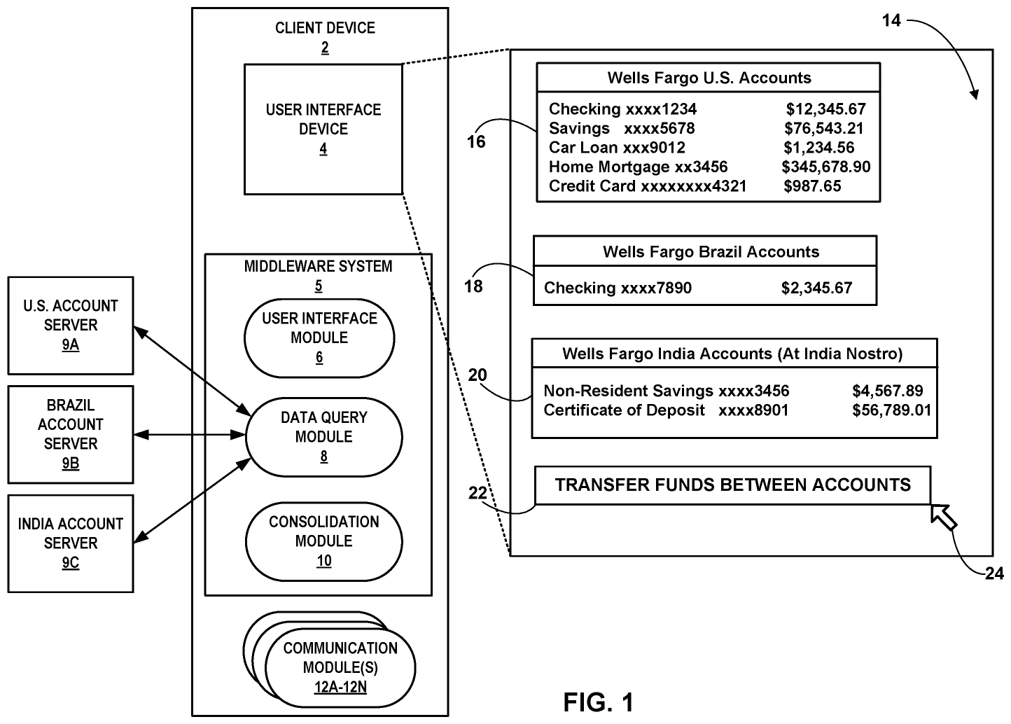

FIG. 1 is a conceptual diagram illustrating details of a client device 2 and a user interface (UI) 14 for a globally consolidated online banking system, in accordance with one or more aspects of this disclosure. Client device 2 may include, be, or be part of one or more of a variety of types of devices including desktop computers, laptop computers (including so-called “netbooks” and “ultrabooks”), mobile phones (such as “smartphones”), personal digital assistants (PDAs), tablet computers, convertible laptop/tablet computers, watches, and various others. As shown in the example of FIG. 1, various elements are shown as being included, stored, or otherwise implemented in client device 2. In some examples, however, one or more of these elements may be included, stored, or otherwise implemented in one or more devices that are separate and distinct from client device 2. In such examples, the one or more devices that are separate and distinct from client device 2 are coupled (physically, communicatively, and/or operatively) to client device 2. Client device 2 may access functionalities of remotely-implemented modules in implementing the variable query generation techniques of this disclosure.

As shown, client device 2 may include UI device 4. UI device 4 may represent any device or combination of devices that may provide or output UI 14 for display. Examples of UI device 4 may comprise a liquid crystal display (LCD) monitor, a light emitting diode (LED) monitor, a cathode ray tube (CRT) monitor. In some examples, UI device 4 may comprise a combined input/output device, by which a user may avail of the interactive aspects of UI 14. Examples of combined input/output devices that UI device 4 may include are a touchscreen, a resistive touchscreen, a capacitance-detecting screen, infrared grid-based systems, or an optical imaging-based input device.

In other examples, client device 2 may include dedicated input devices that are separate from, but communicatively coupled to, UI device 4. Some non-limiting examples of dedicated input devices that client device 2 may include are a mouse, keyboard, microphone, joystick, scanner, light pen, digital pen, or a combined device that including a keyboard with a trackball, joystick, or a trackpad. Whether UI device 4 includes combined input/output functionalities, or draws input from dedicated input devices, client device 2 may implement UI 14 as an interactive interface in that client device 2 may update UI 14 in response to receiving user input. In various examples, client device 2 may process a portion of the user input to update UI 14, or may relay the input to another device (e.g., one or more servers) for processing, and then update UI 14 based on instructions received from the other device that processes the relayed input.

Client device 2 may also include UI module 6. UI module 6 may generate UI 14, and cause UI device 4 to display UI 14. UI module 6 may generate and/or modify UI 14 based on data received from other modules or components of client device 2. In the example of FIG. 1, UI module 6 may generate UI 14 to include several elements, some non-limiting examples of which are illustrated in FIG. 1. Additionally, UI module 6 may provide cursor 24, which may move within UI 14 responsive to user input received using an input device such as a mouse, touchpad, or stylus or an input portion of UI device 4 if UI device 4 provides combined input/output functionalities. In turn, the user may select or activate various elements of UI 14 by placing cursor 24 over the element, and providing a selection input, such as a click or a tap gesture. In the example of FIG. 1, a user has placed cursor 24 over fund transfer button 22 (e.g., by “mousing over” fund transfer button 22).

In the example of FIG. 1, UI module 6 causes UI device 4 to include U.S. account field 16, Brazil account field 18, India nostro account field 20, and fund transfer button 22 in UI 14. Collectively, U.S. account field 16, Brazil account field 18, and India nostro account field 20 are referred to herein as “the account fields.” As such, the combination of UI elements included in UI 14 may represent one particular instance of a globally consolidated online banking interface, in accordance with one or more user-facing aspects of this disclosure.

Client device 2 may retrieve the data included in the account fields of UI 14 from other devices, such as servers and/or middleware systems. For instance, data query module 8 of client device 2 may use one or more of communication modules 12A-12N (hereinafter, “communication modules 12”) to query one or more servers for digital data reflecting financial information pertaining to one or more of the account fields included in UI 14. Data query module 8, as well as other components of client device 2, may use communication modules 12 to communicate with external devices via one or more networks, such as wired networks, wireless networks, or any combination thereof.

Communication modules 12 may include a network interface card, such as an Ethernet card, an optical transceiver, a radio frequency transceiver, or any other type of device that can send and receive information. Other examples of such network interfaces may include Bluetooth®, 3G and WiFi® radios in mobile computing devices, as well as Universal Serial Bus (USB). Communication modules 12 may also implement logic to operate the network interface devices listed above, such as by implementing instructions that cause the network interface device(s) to relay queries and receive digital data as described in this disclosure. Thus, communication modules 12 may represent hardware or a combination of hardware and software to support the components, modules, and elements described with respect to client device 2. Optionally, client device 2 may also locally store some portions of the data presented in the account fields of UI 14, either temporarily or on a long-term basis.

Client device 2 may implement each of UI module 6, data query module 8, and consolidation module 10 using various components, such as middleware system 5. Middleware system 5 may, in various implementations, include any combination of one or more processors, one or more field programmable gate arrays (FPGAs), one or more application specific integrated circuits (ASICs), and one or more application specific standard products (ASSPs). Middleware system 5 may also include memory, both static (e.g., hard drives or magnetic drives, optical drives, FLASH memory, EPROM, EEPROM, etc.) and dynamic (e.g., RAM, DRAM, SRAM, etc.), or any other computer-readable storage device or non-transitory computer readable storage medium capable of storing instructions that cause the one or more processors (e.g., control unit 202) to perform the efficient network management techniques described in this disclosure.

Thus, middleware system 5 may represent hardware or a combination of hardware and software to support the below described components, modules or elements, and the techniques should not be strictly limited to any particular embodiment described below. Although UI module 6, data query module 8, and consolidation module 10 of client device 2 are illustrated as being included within middleware system 5 in the example of FIG. 1, it will be appreciated that one or more of these components may also incorporate or invoke other components of client device 2 in various implementations.

As described above, data query module 8 may use communication modules 12 to send data queries to one or more servers, and also to receive digital financial data from the one or more servers. For instance, data query module 8 may elicit the financial data as a response to the queries sent to the server(s). Although data query module 8 may communicate with a single server or with any number of servers to gather the financial data reflected in the account fields of UI 14, for ease of discussion purposes only, the functionalities of data query module 8 are described herein with respect to communications with a separate single server for financial data pertaining to each jurisdiction illustrated in the account modules of UI 14.

In the particular example illustrated in FIG. 1, data query module 8 may communicate one or more queries to one or more servers for financial data pertaining to several U.S. accounts, a single Brazil account, and two India accounts. For instance, data query module 8 may query a U.S. account server 9A for financial data pertaining to the five U.S. accounts listed in U.S. account field 16, namely, a checking account, a savings account, a car loan (or auto loan), a home mortgage, and a credit card. Data query module 8 may also query a Brazil account server 9B for financial data pertaining to a checking account. Additionally, data query module 8 may query an India account server 9C for financial data pertaining to two accounts, namely a non-resident savings account and a certificate of deposit. While the separate servers are identified by the name of the jurisdiction for which each server stores financial data, it will be appreciated that each server may or may not be physically located in its corresponding financial jurisdiction.

The financial data presented in the account modules of UI 14 represent financial data that data query module 8 may gather from both open loop and closed loop banking systems. In the example of FIG. 1, the financial data presented in U.S. account field 16 and Brazil account field 18 represent global financial data that data query module 8 gathered from a closed loop system. As used herein, the term “closed loop system” refers to an international banking scenario in which a single bank (or “host bank”) maintains operations in all jurisdictions. More specifically, in the example of FIG. 1, the host bank maintains operations in both the U.S. and in Brazil. Thus, the financial data of U.S. account field 16 and Brazil account field 18 represent financial data of a closed loop system, as collected by data query module 8 from the U.S. server and the Brazil server.

Conversely, the financial data presented in U.S. account field 16 and India account field 20 represent global financial data that data query module 8 gathered from an open loop system. As used herein, the term “open loop system” refers to an international banking scenario in which the host bank maintains operations in a true subset (i.e. some, but not all) of jurisdictions. In any foreign jurisdiction(s) where the host bank does not maintain its own operations, the host bank may itself be a banking client of a local bank or financial institution. A local bank that operates in a foreign jurisdiction and services a bank account for the host bank is referred to herein as a “nostro” bank.

The host bank may facilitate a customer's transactions in the foreign jurisdiction by using the host bank's own assets held at the nostro bank, and then reconcile the foreign transaction using the customer's funds held at the host bank. In the example of FIG. 1, the host bank maintains its own operations in the U.S., and maintains a bank account with a nostro bank in India. Thus, the financial data of U.S. account field 16 and India account field 20 represent financial data of an open loop system, as collected by data query module 8 from the U.S. account server 9A and the India account server 9C. It will be appreciated that the user's India accounts may be held at any bank in India, and not necessarily at the same bank where the host bank holds its nostro account. Regardless of the specific bank(s) at which the user holds his/her India account(s), the host bank may implement the techniques of this disclosure to service the user's India account(s) using the host bank's funds held in the nostro account in India.

As shown in FIG. 1, client device 2 may implement the techniques of this disclosure to output account information from multiple jurisdictions, including one or both of closed loop and open loop systems via a single interface, namely, UI 14. For instance, consolidation module 10 may group all of the financial account data collected by data query module 8 from the remote servers. In the example of FIG. 1, consolidation module 10 may group all financial data for a single customer of the host bank, across various jurisdictions.

For instance, consolidation module 10 may use a username registered with the host bank to identify a single user of the host bank's online bank system. In various use case scenarios, user interface module 6 may receive the username via an online banking login by a customer. Consolidation module 10 may determine that a subset of financial account data retrieved by data query module 8 are linked, based on the subset of financial account data being associated with a single username. Consolidation module 10 may group all financial account data retrieved by data query module 8 that are associated with a single username, to form the consolidated global financial information or “true global account” of this disclosure.

Consolidation module 10 may provide the true global account information for a currently logged-in customer to UI module 6. In turn, UI module 6 may output all of the financial data assigned to the logged-in customer, as retrieved by data query module 8. In this manner, various components of middleware system 5 of client device 2 may implement the techniques of this disclosure to consolidate a customer's financial information to form a true global account, and provide the true global account information to the customer via a consolidated interface (e.g., UI 14).

In the implementation illustrated in FIG. 1, middleware system 5 (and/or various components thereof) generate and output the financial data of the customer's true global account in a single currency, e.g., U.S. dollars. In various examples, middleware system 5 may select the single currency based on different criteria, such as user-specified settings, a default currency selection, a current location of client device 2, etc. In examples where middleware system 5 selects the currency based on the current location of client device 2, middleware system 5 may determine the current location based on various contextual information, such as global positioning system (GPS) coordinates, cellular signal carrier identification information, internet protocol (IP) address information assigned to client device 2 by a router, etc. In this manner, middleware system 5 may generate the true global account financial data of UI 14 adaptively.

UI module 6 may implement UI 14 as an interactive interface, in that UI module 6 may enable a user to input information via UI 14. For instance, UI module 6 may enable the user to perform a transaction by placing cursor 24 over fund transfer button 22 (e.g. “mousing over”) and virtually actuating fund transfer button 22 via click, tap, or other selection gesture. In turn, UI module 6 may update UI 14 to present transaction options to the user. Examples of transactions that can be performed via a UI of this disclosure are discussed in greater detail below. UI module 6 may also enable the user to customize various fields of UI 14, or to expand/collapse U.S. account field 16 and India account field 20, as these two account fields include information for multiple accounts.

Thus, according to aspects of this disclosure, client device 2 represents a computing device that includes a memory configured to store digital financial data and a middleware system for processing at least a portion of the digital financial data. The middleware system (middleware system 5 in the example described above) may be configured to obtain first account information that represents a financial account operating in a first national jurisdiction, to obtain second account information that represents a financial account operating in a second national jurisdiction, the second national jurisdiction being mutually exclusive to the first national jurisdiction, and output a combination of the first account information and the second account information via a consolidated user interface (UI).

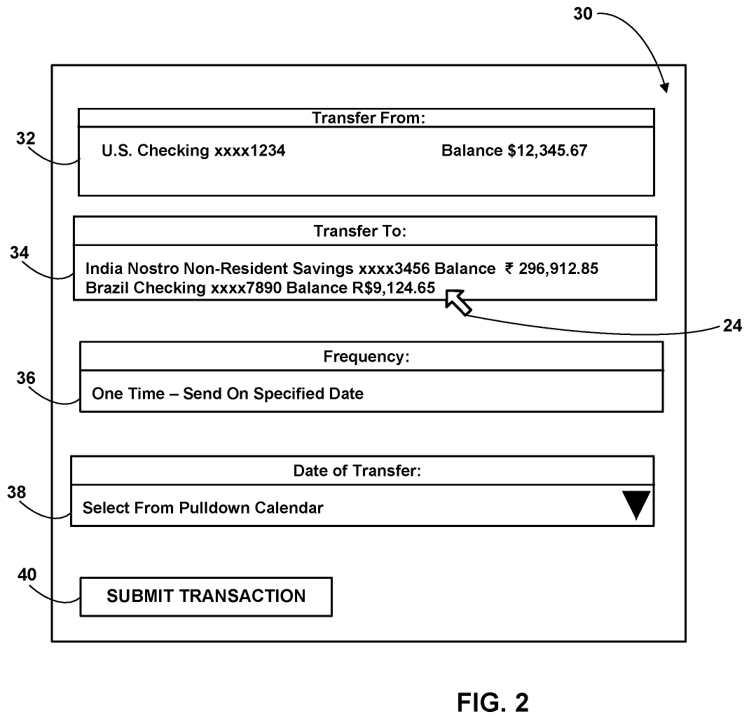

FIG. 2 is a conceptual diagram illustrating details of an example UI 30 for performing global financial transactions using a globally consolidated online banking system using a computing device such as client device 2, in accordance with one or more aspects of this disclosure. UI 30 may represent an updated version of UI 14 that was illustrated in and described with respect to FIG. 1. For instance, UI module 6 may output UI 30 in response to detecting a user selection of the fund transfer button 22. In turn, one or more components of middleware system 5 may generate and output a transaction page, similar to UI 30.

UI 30 represents an interface in which the user has already designated a source account and is in the process of designating a destination account. As shown, UI 30 includes source account dropdown 32, destination account dropdown 34, transaction frequency dropdown 36, transaction date calendar 38, and transaction submission button 40. In the use-case scenario illustrated in FIG. 2, the user has already selected a source account, namely, the U.S. checking account with the account number ending in “1234” shown in source account dropdown 32.

Destination account dropdown 34 is illustrated in an activated state, i.e., destination account dropdown 34 currently shows two or more options from which the user can select. According to various display settings, the activated state of destination account dropdown may include various numbers of selection options. The particular example of FIG. 2 illustrates an implementation in which destination dropdown 34 displays two options in the activated state. If a greater number of options are available for selection, UI module 6 may enable the user to scroll through the options using a mouse, stylus, finger, etc.

As shown in FIG. 2, destination account dropdown 34 includes two accounts that are foreign to the U.S. The first non-U.S. account listed in destination account dropdown 34 is a savings account operating in India and hosted by a nostro bank. The second non-U.S. account listed in destination account dropdown 34 is a checking account operating in Brazil and hosted by a Brazilian entity of the U.S. host bank. However, the selected account in source account dropdown 32 is a U.S. account. In this way, UI 30 is one example of the operability of online banking technology for a true global account according to this disclosure. It will be appreciated that, in various use-case scenarios, destination account dropdown 34 may also include one or more of the U.S. accounts listed in U.S. account field 16 of FIG. 1. In this way, the online banking systems that operate a true global account of this disclosure are backward-compatible in terms of providing single-country online banking support, as well.

Upon selecting one of the non-U.S. bank accounts using destination account dropdown 34, the user may select a transaction frequency using frequency dropdown 36. In the example of FIG. 2, a “one time” frequency is selected (e.g., by way of a prior user selection or a default selection option). Additionally, the selected option of frequency dropdown 36 calls on the user to specify a date on which to perform the transaction. In turn, the user may select a date for the funds transfer using transaction date dropdown 38. In an example where a “send now” option is selected using frequency dropdown 36, transaction date dropdown 38 may be deactivated or “grayed out” as the transaction date would be the same day that the user sets up the transaction via UI 30. Other options that frequency dropdown 36 may include are recurring transfer options, with varying frequencies, such as weekly, bi-weekly/fortnightly, monthly, etc. In these scenarios, the user's selection via transaction date dropdown 38 may represent a starting date for the recurring transfer(s). The user may effect the transaction set up via UI 30 by virtually actuating submission button 40.

UI 30 is an example of an implementation in which middleware system 5 generates and outputs financial account information using the currency of the country in which each account is operated. As shown, the balance amount for the U.S. checking account in source account dropdown 32 is denoted in U.S. dollars (using the “$” symbol). In contrast, the balances for the India savings account and the Brazil checking account are denoted in Indian rupees (using the “ [symbol] ” symbol) and in Brazilian reals (using the “R$” symbol) respectively.

By way of UI 30, middleware system 5 may enable a user to use a single online banking interface to transact between accounts in different countries, where the accounts are operated using local currencies in their home countries. Thus, middleware system 5 may implement UI 30 to enable an online banking user or customer to perform both international and domestic transactions using a single online banking interface, in accordance with one or more aspects of this disclosure. In this manner, UI 30 represents an example transaction interface for a true global account, in accordance with one or more aspects of this disclosure.

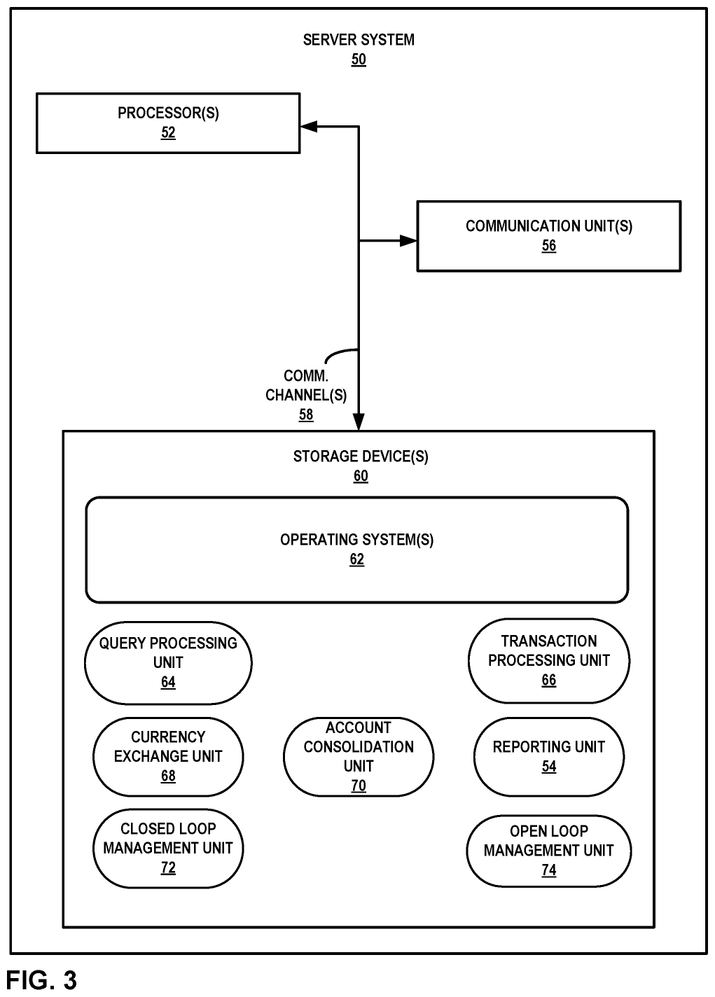

FIG. 3 is a block diagram illustrating details of an example server system 50 for implementing globally consolidated online banking, in accordance with one or more aspects of this disclosure. Although shown in FIG. 3 with respect to a single device for ease of illustration, the functionalities described with respect to server system 50 may be distributed across multiple devices at different locations. Server system 50 may also form any component or system that includes a processor (e.g., processor(s) 32) or other suitable computing environment for executing instructions and, for example, need not include one or more of the elements shown in FIG. 3.

As shown in the example of FIG. 3, server system 50 may include one or more processors 52, one or more communication units 56, one or more communication channels 58, and one or more storage devices 60. Each of components 52, 56, and 60 may be interconnected (physically, communicatively, and/or operatively) for inter-component communications. In some examples, communication channel(s) 58 may include a system bus, network connection, inter-process communication data structure, or any other channel for communicating data. As one example in FIG. 3, components 52, 56, and 60 may be coupled by one or more communication channel(s) 58.

Processor(s) 52, in one example, are configured to implement functionality and/or process instructions for execution within server system 50. For example, processor(s) 52 may be capable of processing instructions stored in storage device(s) 60. Examples of processor(s) 52 may include, any one or more of a microprocessor, a controller, a digital signal processor (DSP), an application specific integrated circuit (ASIC), a field-programmable gate array (FPGA), or equivalent discrete or integrated logic circuitry.

One or more storage devices 60 may be configured to store information within server system 50 during operation. Storage device(s) 50, in some examples, are described as a computer-readable storage medium and/or as one or more computer-readable storage devices. In some examples, storage devices 60 comprise temporary memory, meaning that a primary purpose of storage device(s) 60 is not long-term storage. Storage device(s) 60, in some examples, are described as a volatile memory, meaning that storage device(s) 60 do not maintain stored contents when the computer is turned off. Examples of volatile memories include random access memories (RAM), dynamic random access memories (DRAM), static random access memories (SRAM), and other forms of volatile memories known in the art. In some examples, storage device(s) 60 are used to store program instructions for execution by processor(s) 52. Storage device(s) 60, in one example, are used by software or applications running on server system 50 to temporarily store information during program execution.

Storage device(s) 60, in some examples, also include one or more computer-readable storage media. Examples of such computer-readable storage media may include a non-transitory computer-readable storage medium, and various computer-readable storage devices. Storage device(s) 60 may be configured to store larger amounts of information than volatile memory. Storage device(s) 60 may further be configured for long-term storage of information. In some examples, storage device(s) 60 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

In the implementation illustrated in FIG. 3, server system 50 also includes one or more communication units 56. Server system 50 may utilize communication units 36 to communicate with external devices via one or more networks, such as one or more wireless networks. For instance, server system 50 may use communication units 56 to communicate with client device 2 of FIG. 1. Communication units 56 may include a network interface card, such as an Ethernet card, an optical transceiver, a radio frequency transceiver, or any other type of device that can send and receive information. Other examples of such network interfaces may include Bluetooth®, 3G; 4G and WiFi® radios computing devices as well as Universal Serial Bus (USB). In some examples, server system 50 utilizes communication units 56 to wirelessly communicate with an external device.

Server system 50 may also implement one or more aspects of operating system 62. Operating system 62, in some examples, controls the operation of components of server system 50. For example, operating system 62 may facilitate the communication of various units illustrated in storage devices 60 with processor(s) 52 and communication unit(s) 56. As shown in FIG. 3, storage device(s) 60 may include or otherwise facilitate in implementing query processing unit 64, transaction processing unit 66, currency exchange unit 68, account consolidation unit 70, reporting unit 54, closed loop management unit 72, and open loop management unit 74. In various implementations, the functionalities described with respect to a single unit may be distributed among multiple units, or conversely, the functionalities described with respect to multiple units herein may be combined into a fewer number of units.

Server system 50 may invoke or otherwise use query processing unit 64 in response to receiving a data request from data query module 8 of client device 2. In turn, query processing unit 64 may retrieve and/or generate financial account information in response to a request received from data query module 8. As described above with respect to FIG. 1, data query module 8 may send requests for current account balances and other status information with respect to financial accounts operating in diverse countries. In response to such a request, query processing unit 64 may retrieve the current account information from storage device(s) 60, if the current account information for any of the requested countries is stored locally on storage device(s) 60.

In some examples, some or all of the requested financial account information may be stored externally to storage device(s) 60. For instance, some country-specific account information may be stored on a server other than server system 50. In these examples, query processing unit 64 may relay the received request, or generate and transmit a new request, via communication unit(s) 56. As one example, if the request received from data query module 8 includes a request for information pertaining to a nostro account, query processing unit 64 may communicate with the nostro bank's server using communication unit(s) 56. For instance, query processing unit 64 may process the received request to determine that the request is associated with the host bank's nostro account. In turn, query processing unit 64 may generate a secondary request for the host bank's nostro account balance and transmit the secondary request via communication unit(s) 56. Based on the received nostro account balance, query processing unit 64 may determine the percentage of the nostro account balance that is allotted to the user who generated the request at client device 2. In this manner, query processing unit 64 may implement the global account consolidation techniques of this disclosure to service user requests for current account information pertaining to accounts operating in diverse international jurisdictions.

As shown in FIG. 3, server system 50 also includes transaction processing unit 66. Transaction processing unit 66 may perform transactions using one or more accounts of a user's true global account, in accordance with one or more aspects of this disclosure. In various examples, transaction processing unit 66 may perform transactions between separate accounts operating in the same country, separate internationally diverse accounts under a shared true global account umbrella, or between an account under the true global account umbrella and an account that is not associated at all with the user of the true global account.

As an example of a transaction between internationally diverse accounts under a single true global account umbrella, transaction processing unit 66 may receive a fund transfer request submitted by a user through UI 30 of FIG. 2. For instance, the fund transfer request may reflect a transfer of funds from the U.S. checking account selected via source account dropdown 32 to the Brazil checking account shown in destination account dropdown 34. Upon receiving the fund transfer request, transaction processing unit 66 may process the request to determine the number of U.S. dollars that the user is attempting to transfer out of the U.S. checking account.

Additionally, transaction processing unit 66 may process the fund transfer request to determine that the user's selected destination account is an account operating in a non-U.S. jurisdiction, e.g., Brazil. Based on these detected characteristics of the fund transfer request, transaction processing unit 66 may determine that the fund transfer request is an international transfer within a single customer's true global account. In turn, based on the international nature of the requested transaction, transaction processing unit 66 may invoke currency exchange unit 68. More specifically, transaction processing unit 66 may invoke currency exchange unit 68 based on the determination that the requested transfer involves accounts in to countries that use different currencies, namely, the U.S. and Brazil.

Upon being invoked by transaction processing unit 66, currency exchange unit 68 may determine the current exchange rate between the U.S. dollar and the Brazilian real. In various use cases, currency exchange unit 68 may obtain the current exchange rate by requesting the rate from remote devices using communication unit(s) 56. For instance, currency exchange unit 68 may use communication unit(s) 56 to communicate the currency pair (in this case, a {U.S. dollar, Brazilian real} pair) to an asset management device that is external to server system 50.

In response, currency exchange unit 68 may receive a U.S. dollar to Brazilian real exchange rate at a particular time. In various examples, currency exchange unit 68 may obtain the exchange rate at a time corresponding to a timestamp associated with the submission of the request via UI 30, a time that the asset management system receives the request from currency exchange unit 68, etc. In various implementations, currency exchange unit 68 may include, be, or be part of an exchange monitoring system that maintains or receives feeds of real-time exchange data for bilateral or multilateral currency exchange rates. Based on the currency exchange rate determined for the selected time and currency pair (in this case, the {U. S. dollar, Brazilian real} pair), currency exchange unit 68 may supply the rate information to transaction processing unit 66.

In turn, transaction processing unit 66 may perform an international debit-credit operation. More specifically, transaction processing unit 66 may deduct the number of U.S. dollars specified in the fund transfer request from the U.S. checking account selected via source account dropdown 32. Additionally, transaction processing unit 66 may multiply the deducted dollar amount by the U.S. dollar to Brazilian real exchange rate in order to determine the number of Brazilian reals corresponding to the deducted U.S. dollar amount.

Transaction processing unit 66 may add the resulting Brazilian real amount to the balance of the Brazil checking account selected by way of destination account dropdown 34. In various examples, transaction processing unit 66 may perform the deduction and addition operations by updating account records stored on storage device(s) 60, by transmitting one or both of the operational commands to remote servers that maintain the account information. In this manner, transaction processing unit 66 and currency exchange unit 68 may implement the techniques of this disclosure to perform international transactions between a single user's accounts under a true global account umbrella.

Account consolidation unit 70 of server system 50 may implement one or more techniques of this disclosure to group data for internationally diverse financial accounts under a single true global account umbrella. As described above with respect to FIG. 1, global account consolidation techniques of this disclosure may be performed by client device 2, by server system 50, or may be distributed among both. In some examples where global account consolidation is performed on the server side (i.e. at server system 50 in this example), account consolidation unit 70 may group the data for two or more of the account fields 16, 18, and 20 illustrated in FIG. 1. In these examples, account consolidation unit 70 may supply the globally consolidated account information to client device 2, using communication unit(s) 56.

In the example of FIG. 3, server system 50 also includes reporting unit 54. Reporting unit 54 may be an optional component of server system 50 in that one or more functionalities, and possibly all functionalities, described with respect to report unit 54 may be performed externally to server system 50, such as by middleware system 5 of client device 2. Reporting unit 54 may determine which data are to be presented to a user of an online banking system viewing a true global account in accordance with aspects of this disclosure. For instance, report unit 54 may select which details of each account can be output via UI 14 and/or UI 30. Examples of account details include the last four digits of an account number, the type of account (e.g., checking account, home mortgage, etc.), the currencies in which one or more account balances are displayed, etc.

Additionally, in some examples, reporting unit 54 may configure visual aspects of the data displayed via UI 14 and/or UI 30. For instance, reporting unit 54 may configure the account groupings displayed in account fields 14-18, the headings for each of account fields 14-18, and other aspects of the visual display of UI 14 and/or UI 30.

In the example of FIG. 3, server system 50 also includes closed loop management unit 72. Various components of server system 50 and/or other external devices may invoke closed loop management unit 72 to process account monitoring and transactional interactions with internationally diverse financial accounts which are provided within a closed loop banking system. As described above, a banking system is described herein as being “closed loop” if the host bank maintains operations in all of the (multiple) national jurisdictions involved. For instance, closed loop management unit 72 may identify all accounts held at the host bank that are associated with a single user, based on a username provided via client device 2 or using identification information associated with the user. Examples of identification information include a social security number (with respect to identifying U.S. accounts), know your customer (“KYC”) information provided by the user (with respect to identifying accounts in certain non-U.S. jurisdictions, and various others.

In the particular examples described in this disclosure, closed loop management unit 72 may process information for the accounts reflected in U.S. account field 16 and Brazil account field 18 of FIG. 1, because the accounts of U.S. account field 16 and Brazil account field 18 reflect a closed loop system. For instance, transaction processing unit 66 may invoke closed loop management unit 72 in order to effect financial transactions between the U.S. checking account selected in source account dropdown 32 and the Brazil checking account (if selected) of destination account dropdown 34. Based on closed loop management unit 72 identifying the selected U.S. and Brazil checking accounts as being contained within the host bank's closed loop system, transaction processing unit 66 may determine the transaction fees (or inapplicability thereof) with respect to money transfers between the selected U.S. and Brazil checking accounts.

Additionally, by using the closed loop banking information generated by closed loop management unit 72, transaction processing unit 66 and/or other components of server system 50 may mitigate or potentially eliminate systemic inefficiencies caused by commonly-used banking mechanisms, such as mechanisms that rely on “batch processing” for transactions. For instance, a batch processing-based system may rely on queuing up transaction requests, and then effecting the transactions once the queue reaches a threshold number or “critical mass.” In contrast, the closed loop management unit 72 may implement the techniques of this disclosure to enable transaction processing unit 66 to process inter-account transactions on an as-requested basis, in cases where all of the accounts involved in the transaction are operated by branches of the host bank. In this manner, closed loop management unit 72 may implement the techniques of this disclosure to improve the efficiency of international transactions in a closed loop banking system.

Additionally, according to currently-used techniques, a host bank may incur financial costs in performing international transactions within a closed loop banking system. For instance, the host bank may incur fees in performing currency exchanges in transferring funds internationally, even if both the source and destination accounts are within a closed loop banking system. However, using the information relayed by closed loop management unit 72 of this disclosure, transaction processing unit 66 may perform simultaneous, or near-simultaneous, debit-credit of the user's accounts with the host bank's branches in two different countries (e.g., the U.S. and Brazil). By performing such coordinated debit-credit operations using the data provided by closed loop management unit 72, transaction processing unit 66 may reduce or potentially eliminate the transactional costs involved in performing international funds transfers within a closed loop banking system. In this manner, closed loop management unit 72 may implement the techniques of this disclosure to reduce the costs involved in performing international transactions, while maintaining the accuracy of the transaction amount and potentially reducing the time required by the transaction.

In the example of FIG. 3, server system 50 also includes open loop management unit 74. Various components of server system 50 and/or other external devices may invoke open loop management unit 74 to process account monitoring and transactional interactions with internationally diverse financial accounts which are provided using an open loop banking system. As described above, a banking system is described herein as being “open loop” if the host bank maintains operations in only some, but not all, of the multiple national jurisdictions involved. Rather, the host bank may hold an account at a nostro bank, such that the host bank is itself the “customer” with respect to the nostro account. Open loop management unit 74 may identify all accounts held at the host bank that are associated with a single user. Additionally, open loop management unit 74 may identify the appropriate nostro account based on the destination country named in the transaction request submitted by the user via UI 30. For instance, open loop management unit 74 may identify the account number of the nostro account held in the destination country. Additionally, open loop management unit 74 may calculate a percentage of the nostro account balance that is available to the user. For instance, the percentage of the nostro account balance available to the user may be proportional to the current balance of user's account held at the host bank in the host country.

In the particular examples described in this disclosure, open loop management unit 74 may process information for the accounts reflected in U.S. account field 16 and India account field 20 of FIG. 1, because the accounts of U.S. account field 16 and India account field 20 reflect an open loop system. For instance, transaction processing unit 66 may invoke open loop management unit 74 in order to effect financial transactions between the U.S. checking account selected in source account dropdown 32 and the India non-resident savings account (if selected) of destination account dropdown 34. More specifically, open loop management unit 74 may determine that the any transfer request involving the user's non-resident savings account in an Indian bank is to be serviced using the host bank's funds held in the nostro account. Based on open loop management unit 74 identifying the selected U.S. and India accounts as being required in performing the requested transaction via the open loop system, transaction processing unit 66 may determine the transaction fees (or inapplicability thereof) with respect to money transfers between the selected U.S. and India checking accounts. For instance, the transaction fees may vary, based on whether or not the user's selected destination account (in this case, a non-resident savings account in India) is held at the same Indian bank where the host bank holds its nostro account.

Using the open loop banking information generated by open loop management unit 74, transaction processing unit 66 and/or other components of server system 50 may mitigate or potentially eliminate systemic inefficiencies caused by commonly-used banking mechanisms, such as mechanisms that rely on batch processing for transactions. As described above with respect to closed loop banking systems, a batch processing-based system may rely on queuing up transaction requests, and then effecting the transactions once the queue reaches the threshold number, also referred to as critical mass. In contrast, open loop management unit 74 may implement the techniques of this disclosure to enable transaction processing unit 66 to process inter-account transactions on an as-requested basis. For example, if the user requests a U.S.-to-India transfer via UI 30, transaction processing unit 66 may coordinate a deduction from the user's U.S. checking account at the host bank with an outgoing payment from the nostro account to the user's India savings account.

Transaction processing unit 66 may also coordinate these deduction operations with a purchase of Indian rupees using the deducted amount of U.S. dollars, to replenish the nostro account. In various examples, transaction processing unit 66 may invoke currency exchange unit 68 to provide U.S. dollar to Indian rupee exchange rates at the time of the user's request submission, the time of the coordinated account deductions, or the like. In some instances, transaction processing unit 66 may reduce the Indian rupee amount transferred from the nostro account to the user's India account, in order to compensate for transaction fees that the host bank will incur in replenishing the nostro account. In this manner, open loop management unit 74 may implement the techniques of this disclosure to improve the efficiency and reduce the completion time of international transactions in an open loop banking system.

Moreover, open loop management unit 74 may implement the techniques of this disclosure to reduce the number of steps required for performing international transactions in an open loop banking system. For instance, according to transactional operations that are commonly used currently, a U.S.-India transaction may set off a chain of transactions through one or more intermediate countries (e.g., the Philippines). While the spread of systems such as SWIFT, FasterPay, and ACH have attempted to address these complexities from an operational perspective, a technological solution may further reduce the number of steps required to effect an international transaction via an open loop system.

To this end, open loop management unit 74 may implement the techniques of this disclosure such that an international transaction in an open loop banking system can be completed using banking systems in only the two countries involved in the transactions. As illustrated in the U.S.-India example described above, open loop management unit 74 generates and provides information sufficient to enable to transaction processing unit 66 to complete a U.S.-to-India fund transfer by performing transactions only in the U.S. and in India. More specifically, in this example, open loop management unit 74 enables transaction processing unit 66 to deduct funds from a U.S. checking account, send an outgoing (India domestic) payment from the host bank's nostro account, and to purchase foreign exchange in India to replenish the host bank's nostro account. In this manner, open loop management unit 74 may implement techniques of this disclosure to improve the efficiency and reduce the number of steps and time required to effect an international transaction in an open loop banking system.

Additionally, according to currently-used techniques, the host bank may incur financial costs in performing international transactions using an open loop banking system. In turn, the host bank may pass on portions of these costs to the customer. For instance, the host bank may incur fees at each intermediate stage of an open loop transaction. In turn, the number of intermediate jurisdictions through which the transaction is processed may increase the overall transactional cots. However, using the information relayed by open loop management unit 74 of this disclosure, transaction processing unit 66 may reduce the number of stages at which the host bank can potentially incur transactional fees. In some examples (e.g., where the user's foreign account is hosted at the same bank as the host bank's nostro account), transaction unit 66 may further reduce the stages at which transaction fees may be incurred. By coordinating with the functionalities provided by open loop management unit 74, transaction processing unit 66 may reduce or potentially eliminate the transactional costs involved in performing international funds transfers using an open loop banking system. In this manner, open loop management unit 74 may implement the techniques of this disclosure to reduce the costs involved in performing international transactions, while maintaining the accuracy of the transaction amount and potentially reducing the time required to complete the transaction.

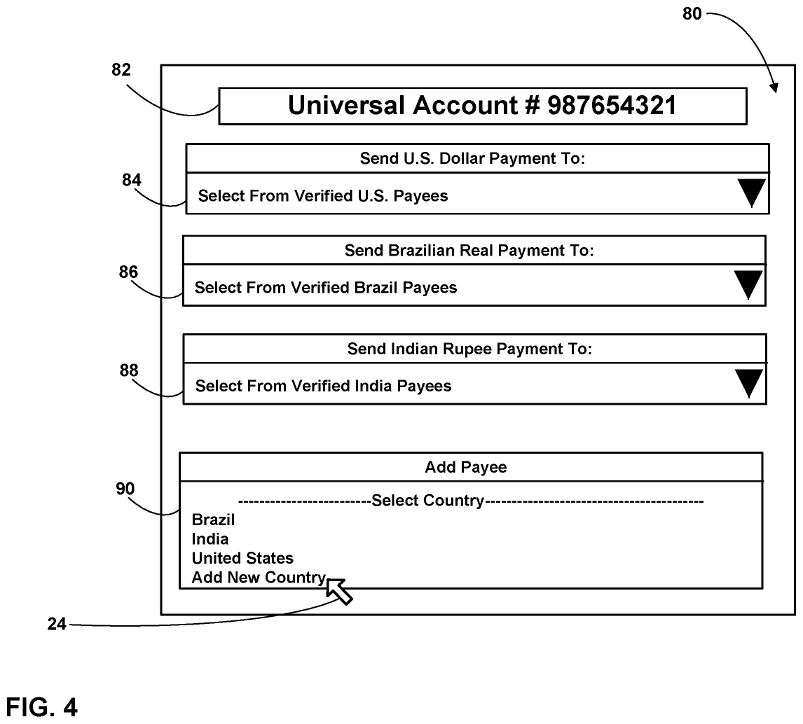

FIG. 4 is a conceptual diagram illustrating an example interactive UI 80 that a computing device (e.g., client device 2 of FIG. 1) may implement for payment management using a globally consolidated online banking system, in accordance with one or more aspects of this disclosure. By way of interactive UI 80, client device 2, server system 50, and various other devices that implement aspects of this disclosure may enable a banking customer to avail of a model payment correspondent system at a personal banking level. For instance, client device 2 may output the user-facing aspects of interactive UI 80 and receive user input via interactive UI 80 to select verified payees for payment from the user's true global account. Further details of the particular implementation illustrated in FIG. 4 are described below.

As shown, client device 2 may configure interactive UI 80 to include universal account identifier 82, U.S. payee dropdown 84, Brazil payee dropdown 86, India payee dropdown 88, and payee addition module 90. Universal account identifier 82 includes a universal or global account number that encompasses all of the user's individual accounts that are grouped under the true global account of this disclosure. For instance, consolidation module 10 of client device 2 and/or account consolidation unit 70 of server system 50 may assign the universal account number to a single customer, and associate the universal account number with all of the individual accounts that are grouped in the customer's true global account. In other examples, the user may set the universal account number via user input. In still other examples, consolidation module 10 and/or account consolidation unit 70 may set the universal account to a default value, such as a phone number associated with the user.

Using the universal account number displayed in universal account identifier 82, client device 2 and server system 50 may enable the user to operate any, some, or all of the individual accounts under the true global account using a single, seamless online banking portal. For instance, the user may monitor account activity in, or perform transactions between, the included international accounts by providing just the universal account number displayed in universal account identifier 82. As another example, the user may send payments to external payees using the universal account number displayed in universal account identifier 82. In this manner, consolidation module 10 of client device 2 and/or account consolidation unit 70 of server system 50 may implement the techniques of this disclosure to enable a customer to operate internationally diverse financial accounts using a single account number.

Additionally, client device 2 and/or server system 50 may implement the techniques of this disclosure to vet and whitelist certain trusted payees in one or more jurisdictions where a customer's true global account encompasses a local account. In the example of FIG. 4, interactive UI 80 includes verified payee dropdowns 84, 86, and 88. By opening U.S. payee dropdown 84, a user may view, and select from, one or more trusted payees (e.g., utility companies and other creditors) that receive U.S. dollar payments. Similarly, the user may open Brazil payee dropdown 86 or India payee dropdown 88, respectively, to view and select from one or more trusted payees that receive Brazilian real or Indian rupee payments.

Transaction processing unit 66 of server system 50 (FIG. 3) may select the trusted payees based on various criteria. As one example, transaction processing unit 66 may receive user input identifying one or more trusted payees via communication units(s) 56. In this example, client device 2 may relay the user input to server system 50 using communication modules 12. The user input may identify the trusted payee(s) using one or more of a name, an address, a destination account number, or any other payee-identifying or recipient account-identifying information.

For instance, the user may add a payee using payee addition module 90 of interactive UI 80. In the example illustrated in FIG. 4, payee addition module 90 is a dropdown or pulldown menu that enables a user to select from the already-listed countries (namely, the U.S., Brazil, and India) in which to add another payee. Payee addition module 90 also enables the user to add another country apart from the three listed countries, in which a payee may reside. For example, even if the user adds a payee in a fourth country via payee addition module 90, the user may potentially use interactive UI 80 to send payments using one of the user's accounts in the U.S., Brazil, and India (e.g., provided that the payee accepts payments in one of the corresponding currencies).

In this and other examples, transaction processing unit 66 may identify the trusted payee(s) based on heuristics data, such as information reflecting a history of past payments from any account of the user's true global account. For instance, if transaction processing unit 66 detects one or more successful payments to a particular payee, using data stored on storage device(s) 60 or from any other source, then transaction processing unit 66 may add the payee to one or more of the trusted payee lists reflected in dropdowns 84-88. For instance, transaction processing unit 66 may the payee to multiple lists of dropdowns 84-88 if the payee accepts payments in multiple corresponding currencies, or if the heuristics data indicates past payments to the same payee from the user's true global account in different currencies. In various examples, transaction processing unit 66 may automatically add a trusted payee, without explicit user input, if the number of payments from the user's true global account to the payee reaches a threshold, if the payment frequency reaches a threshold, or based on various other heuristic data analysis.

In various implementations, the true global account may represent a portable account. For instance, client device 2 and/or server system 50 may enable a customer to use the universal account number when moving one or more of the individual financial accounts included in the true global account. Client device 2 and/or server system 50 may also enable the user to seamlessly add or remove individual accounts from the true global account. The portability of the true global account may also extend to aspects of bank account operation that go beyond online banking, such as by enabling the customer use the same checkbook for any of the individual accounts included in the true global account. The portability of the true global account of this disclosure may also be implemented to enable seamless moves of automatic debits and automatic bill-pay functionalities across accounts included in the true global account.

In some examples, the customer may open the true global account as a “shell” account, in that there are no financial accounts under the umbrella of the true global account at the outset. In turn, the true global account may be “activated” upon the customer linking one or more financial account to the true global account. The portability of the true global account is further reflected in examples where account-related information travels with shifting accounts. Examples of account-related information that is ported with the shifting accounts include transaction histories, bill-pay configuration information, and the like. Server system 50 may also maintain account routing databases that enable the mapping of the universal account number to an individual financial account held at a specific bank (e.g., a branch of the host bank or a nostro bank).

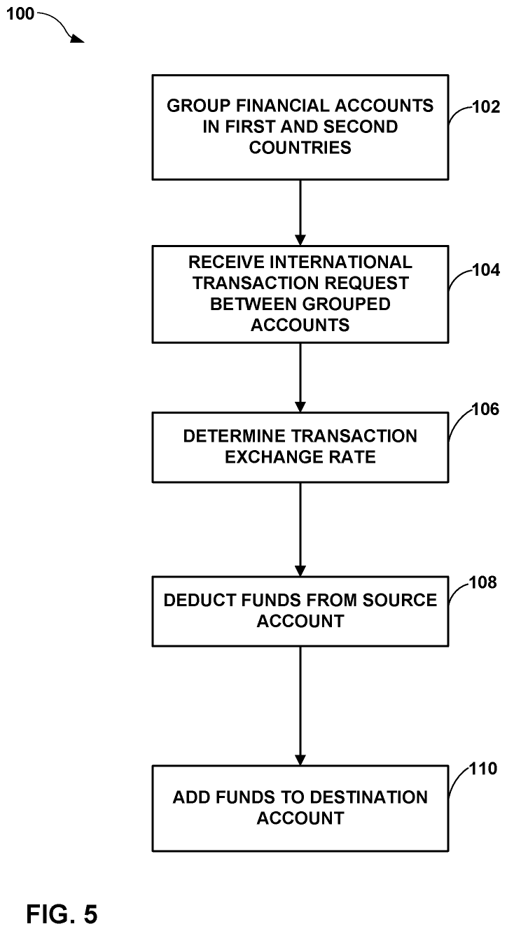

FIG. 5 is a flowchart illustrating an example process 100 that server system 50 may perform to implement one or more global account consolidation techniques of this disclosure. Process 100 may begin when account consolidation unit 70 groups a first financial account associated with a first country and a second financial account associated with a second country to form a consolidated global account (102). Transaction processing unit 66 may receive a transaction request associated with the consolidated global account, where the transaction request is for the first financial account and the second financial account (104). For instance, the transaction request received by transaction processing unit 66 may represent an international transaction request, based on the first and second financial accounts being associated with different countries.

Additionally, currency exchange unit 68 may determine a transaction exchange rate (106). For instance, transaction processing unit 66 may provide the details of the transaction request to currency exchange unit 68. In turn, currency exchange unit 68 may determine a currency exchange rate applicable to the transaction request, where the currency exchange rate is associated with respective currencies of the first country and the second country.

Transaction processing unit 66 may deduct funds from a source account (108). For instance, transaction processing unit 66 may deduct a first transaction amount from the first financial account (in this example, the source account), based on the transaction request and the currency exchange rate determined by currency exchange unit 68. In some examples, transaction processing unit 66 may perform the deducting responsive to determining that the first financial account (e.g., the source account) and the second financial account (e.g., a destination account) are both included in the consolidated global account.

Transaction processing unit may add funds to the destination account (110). For instance, transaction processing unit 66 may add a second transaction amount to the second financial account (in this case, the destination account) based on the transaction request and the currency exchange rate, where the adding is responsive to transaction processing unit 66 determining that the first financial and account and the second financial account are both included in the consolidated global account.

In some examples, to form the consolidated global account, account consolidation unit 70 may determine that both of the first financial account and the second financial account are associated with a common customer entity. In some examples, open loop management unit 74 may determine that the first financial account is maintained by a host bank and the second financial account is maintained by a different bank from the host bank. In these examples, responsive to the determination that the first financial account is maintained by a host bank and the second financial account is maintained by a different bank, open loop management unit 74 may identify a nostro account held in the second country by the host bank, the nostro account being operable to fulfill either a payer-side or payee-side component of a financial transaction described by the transaction request. In some examples, open loop management unit 74 and/or transaction processing unit 66 may determine a share of the nostro account that is accessible for fulfilling the transaction request based on a balance of the first financial account, and may determine whether the transaction request is valid based on whether an amount of the transaction request is within the determined share of the nostro account.

In some examples, closed loop management unit 72 may determine that both of the first financial account and the second financial account are maintained by a common host bank and responsive to the determination, may eliminate batch processing of the transaction request. In some examples, transaction processing unit 66 may identify a trusted payee in the first country, based on heuristic data associated with the first financial account, and may add the trusted payee to a list of trusted payees associated with the consolidated global account.

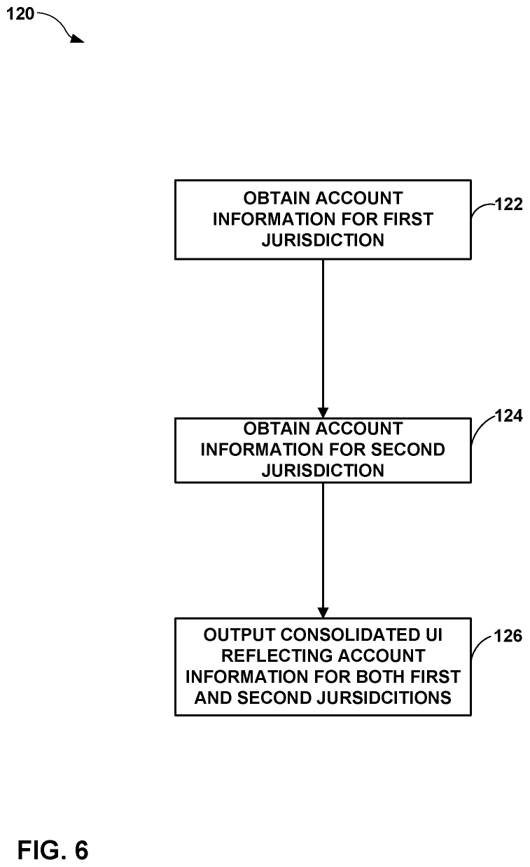

FIG. 6 is a flowchart illustrating an example process 120 that client device 2 may perform to implement one or more global account consolidation techniques of this disclosure. Process 120 may begin when middleware system 5 obtains account information for a first jurisdiction (122). For instance, data query module 8 of middleware system 5 may obtain first account information that represents a financial account operating in a first national jurisdiction. Additionally, middleware system 5 may obtain account information for a second jurisdiction (124). For instance, data query module 8 of middleware system 5 may obtain second account information that represents a financial account operating in a second national jurisdiction, the second national jurisdiction being mutually exclusive to the first national jurisdiction. In turn, middleware system 5 may output a consolidated user interface (UI) reflecting account information for both of the first and second jurisdictions (126). For instance, UI module 6 may cause UI device 4 to output a combination of the first account information and the second account information via a consolidated UI, such as UI 14 of FIG. 1.

In some examples, middleware system 5 may determine that the first account information and the second account information are associated with a common customer entity based on customer-identifying data associated with the common customer entity. In some examples, middleware system 5 may receive a transaction request via the consolidated UI and determine that the transaction request is associated with both of the account operating in the first national jurisdiction and the account operating in the second national jurisdiction. In these examples, middleware system 5 may update the first account information based on the transaction request to form updated first account information, update the second account information based on the transaction request to form updated second account information, and update the consolidated UI to reflect both of the updated first account information and the updated second account information.

In some examples, middleware system 5 may relay the transaction request to one or more server devices, where updating the first account information includes receiving, by the computing device, the updated first account information from the one or more server devices in response to the relayed transaction request, and where updating the second account information includes receiving, by the computing device, the updated second account information from the one or more server devices in response to the relayed transaction request. In some examples, the consolidated UI includes representations of both the first account information and the second account information in a single currency. In some examples, middleware system 5 may select the single currency based on current location information associated with client device 2. In some examples, middleware system 5 may select the single currency based on a currency specified in a user input received by client device 2 (e.g., via UI 14).

In some examples, the consolidated UI includes a representation of the first account information in a first currency and the second account information in a single currency in a second currency that is different from the first currency (e.g., as in the example of UI 30 illustrated in FIG. 2). In these examples, the first currency is associated with the first national jurisdiction and the second currency is associated with the second national jurisdiction. In some examples, the financial account operating in the first national jurisdiction and the financial account operating in the second national jurisdiction are both maintained by a common host bank.

In some examples, the financial account operating in the first national jurisdiction is hosted by a host bank, and the financial account operating in the second national jurisdiction are both maintained by a different bank from the host bank. In some examples, the consolidated UI is associated with a consolidated global account that represents both of the financial account operating in the first national jurisdiction and the financial account operating in the second national jurisdiction. In one such example, the consolidated UI includes a universal account number associated with the consolidated global account (e.g., as in the case of universal account identifier 82 included in interactive UI 80 of FIG. 4).

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media. Computer readable storage media, which is tangible and non-transitory, includes random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other such media. It should be understood that the term “computer-readable storage media” refers to physical storage media, and not signals, carrier waves, or other transient media.

Various examples have been described. These and other examples are within the scope of the following claims.

1. A method comprising:
determining, by a server system, that a common customer entity is associated with both of a first financial account associated with a first country and a second financial account associated with a second country;
based on the determination that the common customer entity is associated with the first financial account and the second financial account, grouping, by the server system, the first financial account and the second financial account to form a consolidated global account for the common customer entity;
receiving, by the server system, a transaction request associated with the consolidated global account, the transaction request being for a fund transfer between the first financial account and the second financial account;
determining, by the server system, that the first financial account is maintained by a host bank and the second financial account is maintained by a different bank from the host bank;
identifying, by the server system, a nostro account held in the second country by the host bank, the nostro account being operable to fulfill one or both of a payer-side or payee-side component of the fund transfer;
determining, by the server system, a share of the nostro account that is accessible for fulfilling the fund transfer based on a balance of the first financial account;
determining, by the server system, that the transaction request is valid based on an amount of the fund transfer being within the determined share of the nostro account; and
in response to determining that the fund transfer is between the first financial account and the second financial account included in the consolidated global account and that the transaction request is valid based on the amount of the fund transfer being within the determined share of the nostro account, performing, by the server system, the fund transfer substantially in real-time, wherein performing the fund transfer substantially in real-time comprises:
determining, by the server system, a currency exchange rate at a particular time applicable to the transaction request, wherein the currency exchange rate is associated with a first currency of the first country and a second currency of the second country;
deducting, by the server system at substantially the same particular time, a first transaction amount in the first currency from the first financial account based on the transaction request and the currency exchange rate; and
adding, by the server system at substantially the same particular time, a second transaction amount in the second currency to the second financial account based on the transaction request and the currency exchange rate.

2. The method of claim 1, wherein determining, by the server system, that both of the first financial account and the second financial account are associated with the common customer entity is based on customer-identifying data associated with the common customer entity.

3. The method of claim 1, further comprising:
subsequent to performing the fund transfer, deducting, by the server system, from the nostro account, the second transaction amount in the second currency.

4. The method of claim 3, further comprising:
reconciling, by the server system, the fund transfer by replenishing the nostro account
using the second currency in the second transaction amount.

5. (canceled)

6. The method of claim 1, further comprising:
identifying, by the server system, a trusted payee in the first country, based on heuristic data associated with the first financial account; and
adding the trusted payee to a list of trusted payees associated with the consolidated global account.

7. A server system comprising:
one or more memory devices configured to store digital financial data; and
one or more processors for processing at least a portion of the digital financial data, the one or more processors being configured to:
determine that a common customer entity is associated with both of a first financial account associated with a first country and a second financial associated with a second country;
based on the determination that the common customer entity is associated with the first financial account and the second financial account, group the first financial account and the second financial account to form a consolidated global account for the common customer entity;
receive a transaction request associated with the consolidated global account, the transaction request being for a fund transfer between the first financial account and the second financial account;
determine that the first financial account is maintained by a host bank and the second financial account is maintained by a different bank from the host bank;
identify a nostro account held in the second country by the host bank, the nostro account being operable to fulfill one or both of a payer-side or payee-side component of the fund transfer;
determine a share of the nostro account that is accessible for fulfilling the fund transfer based on a balance of the first financial account;
determine that the transaction request is valid based on an amount of the fund transfer being within the determined share of the nostro account; and
perform, in response to the determination that the fund transfer is between the first financial account and the second financial account included in the consolidated global account and the determination that the transaction request is valid based on the amount of the fund transfer being within the determined share of the nostro account, a financial transaction substantially in real-time, wherein to perform the financial transaction substantially in real-time, the one or more processors are configured to:
determine a currency exchange rate at a particular time applicable to the transaction request, wherein the currency exchange rate is associated with a first currency of the first country and a second currency of the second country;
deduct, at substantially the same particular time, a first transaction amount in the first currency from the first financial account based on the transaction request and the currency exchange rate; and
add, at substantially the same particular time, a second transaction amount in the second currency to the second financial account based on the transaction request and the currency exchange rate.

8-25. (canceled)

26. The method of claim 1, further comprising determining, by the server system, the second transaction amount in the second currency by deducting, in the second currency, a transaction fee associated with transferring the first transaction amount from the first financial account to the nostro account.

27. The server system of claim 7, wherein to determine that both of the first financial account and the second financial account are associated with the common customer entity, the one or more processors are configured to determine that both of the first financial account and the second financial account are associated with the common customer entity based on customer-identifying data associated with the common customer entity.

28. The server system of claim 7, wherein the one or more processors are further configured to deduct from the nostro account, subsequent to the performance of the fund transfer, the second transaction amount in the second currency.

29. The server system of claim 28, wherein the one or more processors are further configured to reconcile the fund transfer by replenishing the nostro account using the second currency in the second transaction amount.

30. The server system of claim 7, wherein the one or more processors are further configured to:
identify a trusted payee in the first country, based on heuristic data associated with the first financial account; and
add the trusted payee to a list of trusted payees associated with the consolidated global account.

31. The server system of claim 7, wherein the one or more processors are further configured to determine the second transaction amount in the second currency by deducting, in the second currency, a transaction fee associated with transferring the first transaction amount from the first financial account to the nostro account.

32. A non-transitory computer-readable storage medium encoded with instructions that, when executed, cause one or more processors of a server system to:
determine that a common customer entity is associated with both of a first financial account associated with a first country and a second financial associated with a second country;
based on the determination that the common customer entity is associated with the first financial account and the second financial account, group the first financial account and the second financial account to form a consolidated global account for the common customer entity;
receive a transaction request associated with the consolidated global account, the transaction request being for a fund transfer between the first financial account and the second financial account;
determine that the first financial account is maintained by a host bank and the second financial account is maintained by a different bank from the host bank;
identify a nostro account held in the second country by the host bank, the nostro account being operable to fulfill one or both of a payer-side or payee-side component of the fund transfer;
determine a share of the nostro account that is accessible for fulfilling the fund transfer based on a balance of the first financial account;
determine that the transaction request is valid based on an amount of the fund transfer being within the determined share of the nostro account; and
perform, in response to the determination that the fund transfer is between the first financial account and the second financial account included in the consolidated global account and the determination that the transaction request is valid based on the amount of the fund transfer being within the determined share of the nostro account, a financial transaction substantially in real-time, at least in part by:
determining a currency exchange rate at a particular time applicable to the transaction request, wherein the currency exchange rate is associated with a first currency of the first country and a second currency of the second country;
deducting, at substantially the same particular time, a first transaction amount in the first currency from the first financial account based on the transaction request and the currency exchange rate; and
adding, at substantially the same particular time, a second transaction amount in the second currency to the second financial account based on the transaction request and the currency exchange rate.

33. The non-transitory computer-readable storage medium of claim 32, wherein the instructions that cause the one or more processors to determine that both of the first financial account and the second financial account are associated with the common customer entity comprise instructions that, when executed, cause the one or more processors to determine that both of the first financial account and the second financial account are associated with the common customer entity based on customer-identifying data associated with the common customer entity.

34. The non-transitory computer-readable storage medium of claim 32, further encoded with instructions that, when executed, cause the one or more processors to deduct from the nostro account, subsequent to the performance of the fund transfer, the second transaction amount in the second currency.

35. The non-transitory computer-readable storage medium of claim 34, further encoded with instructions that, when executed, cause the one or more processors to reconcile the fund transfer by replenishing the nostro account using the second currency in the second transaction amount.

36. The non-transitory computer-readable storage medium of claim 32, further encoded with instructions that, when executed, cause the one or more processors to:
identify a trusted payee in the first country, based on heuristic data associated with the first financial account; and
add the trusted payee to a list of trusted payees associated with the consolidated global account.

37. The non-transitory computer-readable storage medium of claim 32, further encoded with instructions that, when executed, cause the one or more processors to determine the second transaction amount in the second currency by deducting, in the second currency, a transaction fee associated with transferring the first transaction amount from the first financial account to the nostro account.
